(19) United States
(12) Patent Application Publication
(10) Pub. No.: US 2007/0118886 A1
(43) Pub. Date: May 24, 2007

(54) UPDATING SECURITY DATA

(76) Inventor: Cameron Kenneth Martin, Winchester (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/559,073

(22) Filed: Nov. 13, 2006

(30) Foreign Application Priority Data
Nov. 24, 2005 (GB) 0523871.2

(51) Int. Cl. H04L 9/32

(52) U.S. Cl. 726/5

(57) ABSTRACT

For updating first security data, for use with a first server and a second server, wherein the first server and the second server have access to the first security data; and wherein a user is enabled to communicate with the first server and the second server. A generator generates a first token comprising second security data. The first token is secured by applying the first security data. A communication component transmits, via the first server, the first token to the user and permits the user to communicate the first token to the second server. The second server obtains the second security data by applying the first security data to the first token.

### FIELD OF THE INVENTION

The present invention relates to a system for updating security data.

### BACKGROUND OF THE INVENTION

In order to enhance a user's experience when accessing multiple servers in an environment, it is undesirable to request multiple authentications.

In the prior art, a Single Sign On (SS0) environment is provided, wherein once a user has successfully authenticated, that user is not required to present their authentication data (i.e. credentials) again. Examples of credentials are user IDs and passwords, private keys, X.509 certificates, and the like. That is, the established credentials are then used to automatically authenticate the user to all of the servers participating in the SSO environment.

The servers participating in the SSO environment can use symmetric key encryption, wherein each server comprises the same symmetric key (i.e., the key is shared). In another implementation, the SSO environment can use asymmetric key encryption, wherein each server comprises the same private key. In yet another implementation, the servers in the SSO environment can use a shared secret such as a password, a random number, and the like.

A typical process associated with a SSO environment in some prior art products using symmetric key encryption, such as IBM's Lightweight Third Party Authentication (LTPA), will now be described. With reference to the system (100) of FIG. 1, a user at a client computer (105) accesses multiple servers shown here as Server 1 (101) and Server 2 (102) via a network (110). An administrator (115) can also access Server 1 (101) and Server 2 (102).

With reference to FIG. 2, the administrator (115) sends (step 200) a first symmetric key to Server 1 and sends (step 205) the first symmetric key to Server 2. A user, for example using a Web browser, sends (step 210) their user ID and password (i.e. credentials) to be authenticated by Server 1.

Server 1 authenticates (step 215) the user ID and password with an authentication server (not shown). In response to a successful authentication, Server 1 generates (step 215) a token comprising the user's authenticated credentials, typically the user ID only, and encrypts the token using the first symmetric key. The token can comprise other data such as an identifier associated with a network domain associated with the servers in the SSO environment, time of token expiry, and the like.

Server 1 sends (step 220) the token to the client computer (105). In all subsequent requests to Server 1 and Server 2, the client computer (105) sends the token to Server 1 and Server 2 respectively.

In FIG. 2, the client computer (105) sends (step 225) the token to Server 2 as part of a request for a resource. Because Server 1 and Server 2 already have the same symmetric key, in response to receiving the token, Server 2 decrypts (step 230) the token using the first symmetric key. Server 2 then uses the user ID in the token in order to determine whether the user is authorized to access the resource.

Server 2 does not need to challenge the user again for their user ID and password, because presentation of the token is sufficient to authenticate the user. A trust relationship between Server 1 and Server 2 has been established because these servers possess the symmetric key required to encrypt and decrypt the token comprising the user ID.

In response to a successful authorization, Server 2 sends a response (step 235) to the client computer (105). Content associated with the resource can then be sent from Server 2 to the client computer (105).

Thus, by using a token that is passed to multiple servers, all servers in a SSO environment can access a user's credentials without additional prompting, resulting in a seamless experience for the user.

In order to maintain security, there is a requirement to update the symmetric key periodically, because the symmetric key is susceptible to attacks such as traffic analysis. This is particularly important because the format of data stored in a token will often be known to an attacker, thus aiding a traffic analysis based attack.

Since all servers share a symmetric key, the symmetric key needs to be updated for each server participating in the SSO environment.

Currently, this change is executed by an administrator manually at each server, requiring considerable effort. Alternatively, the administrator constructs complex scripts to allow for an updated symmetric key to be sent to each server. For example, in FIG. 2 the administrator (115) sends (step 240) a second symmetric key to Server 1 and sends (step 245) the second symmetric key to Server 2. Developing and maintaining the scripts can be difficult, error-prone and time consuming. For example, an administrator needs to take care not to inadvertently expose the symmetric key when transferring it to the servers.

Alternatively, an updated symmetric key can be distributed by the servers, between the servers. However, this solution requires network access between servers and this is not always possible. For example, the servers may not have knowledge of each other; if network access is available, there can be problems associated with the network such as outage and the like.

### SUMMARY

According to a first aspect, there is provided a system for updating first security data, for use with a first server and a second server, wherein the first server and the second server have access to the first security data; and wherein a user is enabled to communicate with the first server and the second server; the system comprising: a generator for generating a first token comprising second security data, wherein the first token is secured by applying the first security data; and a communication component for transmitting, via the first server, the first token to the user and operable to permit the user to communicate the first token to the second server; and wherein the second server is operable to obtain the second security data by applying the first security data to the first token.

Preferably, the system further comprises an authenticator for authenticating the user. In a preferred embodiment, the system further comprises a first selection component for selecting a server to generate the second security data. More preferably, the first selection component selects a server in accordance with data associated with the user's communication with the selected server. Still more preferably, data associated with the selected server is added to the first token.

In a preferred embodiment, the generator generates a second token comprising a third token associated with credentials of the user and the first token. Preferably, at least one of the first token and second token comprises an identifier associated with an environment having the first server and the second server. More preferably, the system further comprises a second selection component for selecting the user to communicate the first token to the second server.

Preferably, the system further comprises a third selection component for selecting a plurality of users to communicate a plurality of tokens to the second server. More preferably, the generator adds a plurality of portions of the second security data to the plurality of tokens. Still more preferably, in response to receiving the plurality of tokens, the second server aggregates the plurality of portions of the second security data to generate the second security data. Still more preferably, the second server uses an error correction code.

In a preferred embodiment, in response to receiving the second security data, the second server sends an acknowledgment to the first server. Preferably, in response to receiving the acknowledgment, the first server utilizes the second security data.

Preferably, the second security data is used for a pre-configurable time period. More preferably, data associated with the time period is added to at least one of: the first token and the second token. Still more preferably, the first security data is used for a pre-configurable time period.

According to a second aspect, there is provided a method for updating first security data, for use with a first server and a second server, wherein the first server and the second server have access to the first security data; and wherein a user is enabled to communicate with the first server and the second server; the method comprising the steps of: generating a first token comprising second security data, wherein the first token is secured by applying the first security data; and transmitting, via the first server, the first token to the user and operable to permit the user to communicate the first token to the second server; and wherein the second server is operable to obtain the second security data by applying the first security data to the first token.

According to a third aspect, there is provided a computer program comprising program code means adapted to perform all the steps of the method described above when said program is run on a computer system.

### BRIEF DESCRIPTION OF THE DRAWINGS

The present invention will now be described, by way of example only, with reference to preferred embodiments thereof, as illustrated in the following drawings, wherein:

FIG. 1 is a block diagram of a system in which the preferred embodiment may be implemented;

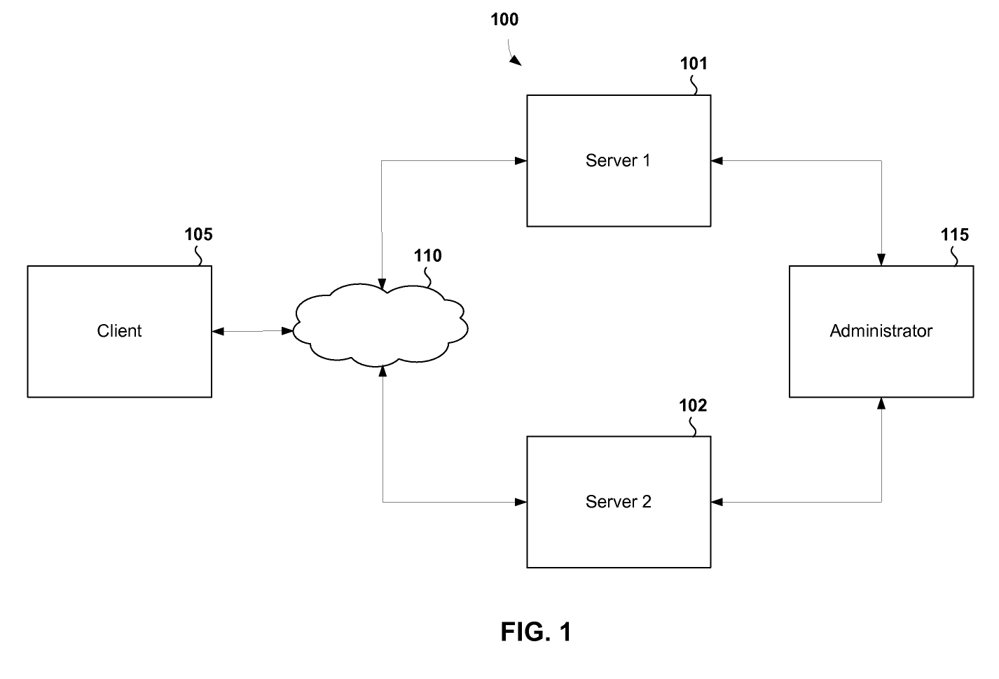

FIG. 2 is a schematic diagram of the components involved in a SSO environment and the flows between those components, according to the prior art;

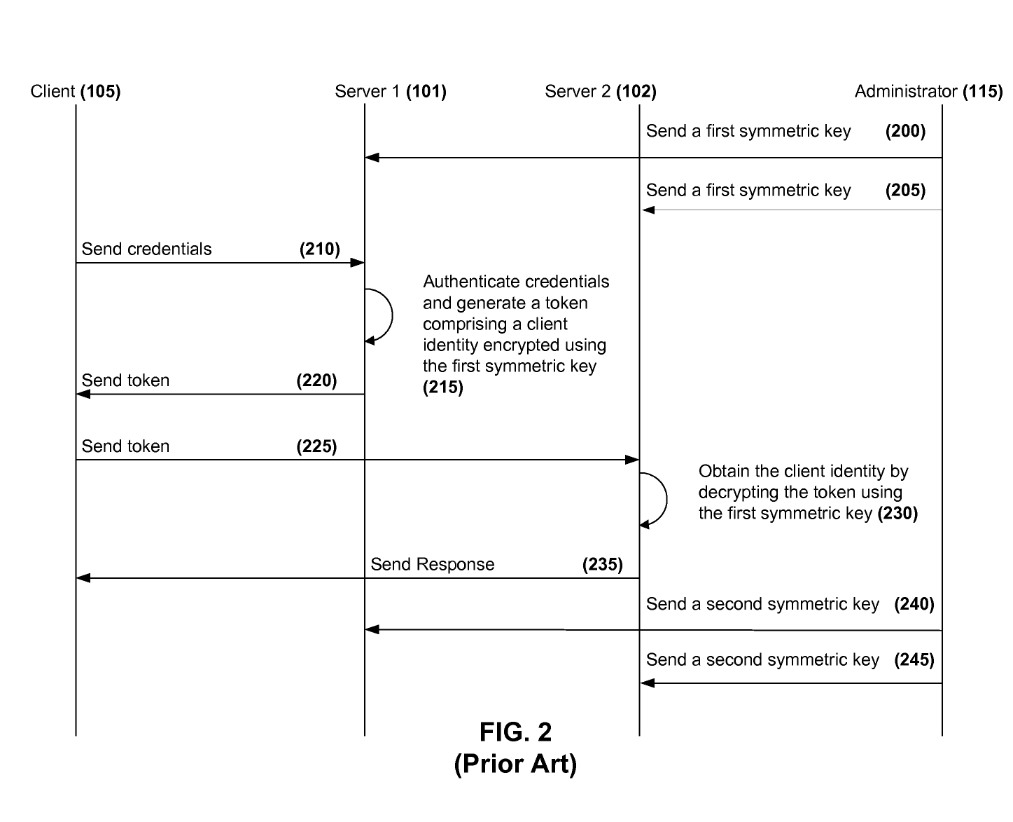

FIG. 3 is a more detailed block diagram of the system of FIG. 1, according to a preferred embodiment; and

FIG. 4 is a schematic diagram of the components involved in a SSO environment and the flows between those components, according to a preferred embodiment.

### DETAILED DESCRIPTION

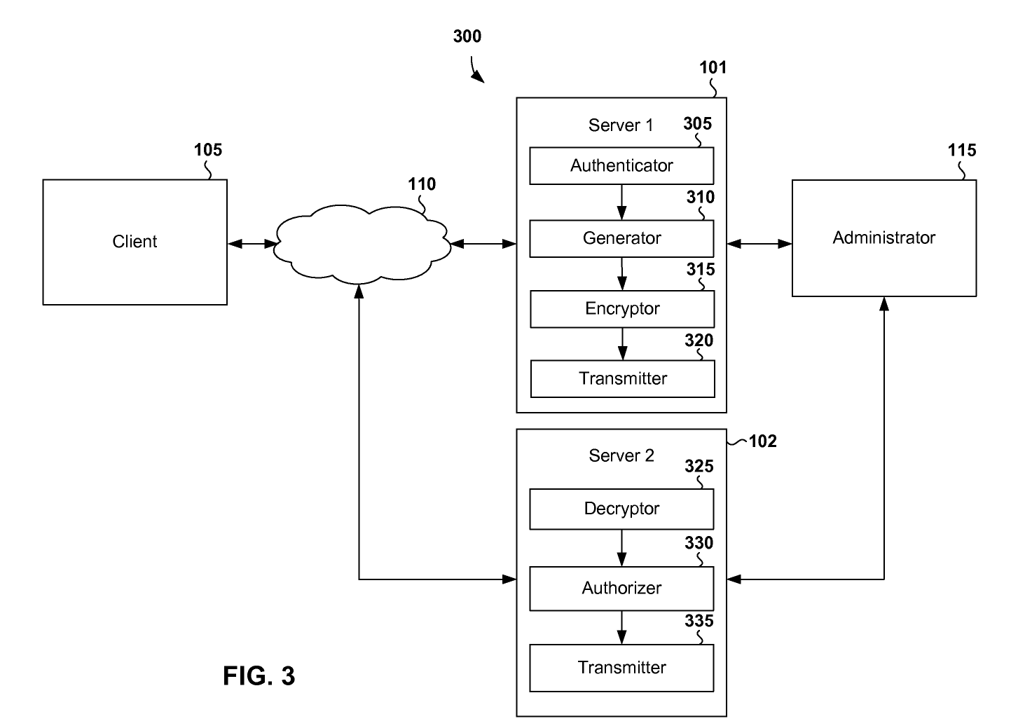

With reference to FIG. 3, there is shown a block diagram of a system (300) in which the preferred embodiment can be implemented. Server 1 comprises an authenticator (305), a generator (310), an encryptor (315) and a first transmitter (320). Server 2 comprises a decryptor (325), an authorizer (330) and a second transmitter (335). It should be understood, that preferably, Server 1 also comprises a decryptor and Server 2 also comprises a generator and an encryptor; these components, however, have not been shown in FIG. 3, for clarity.

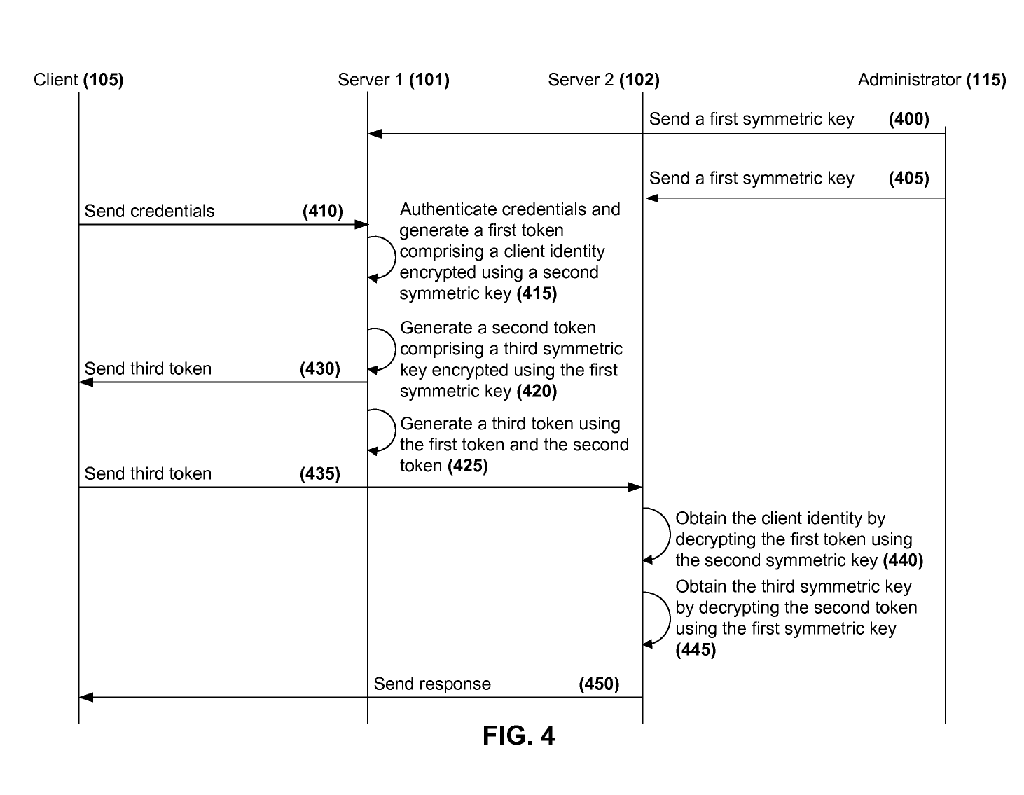

With reference to FIG. 3 and FIG. 4, an administrator (115) sends (step 400) a first symmetric key to Server 1 and sends (step 405) the first symmetric key to Server 2. Preferably, the administrator (115) sends the keys over a secure channel.

A user at a client computer (105) sends (step 410) their credentials to Server 1 to be authenticated. In a first example, the credentials comprise a user ID and a password. In response to receiving the credentials, the authenticator (305) authenticates (step 415) the credentials against an authentication server. In response to an unsuccessful authentication, the process ends. Alternatively, a notification can be sent to the administrator (115).

In response to a successful authentication, the generator (310) generates (step 415) a first token comprising a portion of the credentials. It should be understood that the token can comprise any number of portions of the credentials, such as a user ID only, a user ID and password, and so forth. It should be understood that the token can comprise other data such as time of expiry of the token. In the first example, the first token comprises the user ID. A representation of the first token is shown below:

<token_{—}1> encrypted with second symmetric key (user ID)</token_{—}1>

The encryptor (315) encrypts (step 415) the first token with a second symmetric key.

It should be understood that the second symmetric key can be sent to Server 1 and Server 2 at the same time as sending of the first symmetric key by the administrator (115) (i.e. at steps 400 and 405).

Alternatively, the second symmetric key can be generated by Server 1 and Server 2 using a pre-agreed algorithm which generates the same second symmetric key given a first symmetric key.

Alternatively, Server 1 generates the second symmetric key and the first symmetric key is used to encrypt a token comprising both the user ID and the second symmetric key.

It should be understood that the second symmetric key (i.e., the symmetric key that is used to encrypt a portion of the user's credentials) is required to be updated periodically as described above, for example in order to defeat traffic analysis attacks.

The generator (310) also generates (step 420) a second token comprising a third symmetric key, wherein the third symmetric key is the updated symmetric key to the second symmetric key.

In a preferred implementation, the third symmetric key is generated on a pre-selected server. In a first example, the third symmetric key is generated on a server from which a user receives a token prior to logging onto other servers. For example, if a user more frequently connects first to Server 1 and then to Server 2, and less frequently connects in the reverse order, or if a user must connect to Server 1 before connecting to Server 2, then preferably, the third symmetric key is generated on Server 1. This ensures that the third symmetric key is then transmitted efficiently to other servers.

It should be understood that a server can be pre-selected based on any number of other aspects e.g. probability of key distribution to all other servers; timeliness of key distribution; frequency of key distribution etc.

In one embodiment, an administrator pre-selects a server for generating and distributing a symmetric key.

Alternatively, a selection component (not shown) pre-selects a server for generating and distributing a symmetric key. Preferably, the selection component analyses selection data in order to select a server. For example, the selection component analyses a list of servers that a user has previously connected to. The list can be stored, for example in the user's token. In response to the analysis, the selection component selects a server.

Preferably, data associated with the selected server is added to the second token that is generated in order to transmit the updated symmetric key generated by the selected server.

A representation of the second token is shown below:

<token_{—}2> encrypted with first symmetric key (symmetric_key_{—}3)</token_{—}2>

The encryptor (315) encrypts (step 420) the second token with the first symmetric key received from the administrator (115).

The generator (310) also generates (step 425) a third token comprising the first token and the second token. A representation of the third token is shown below:

<token_{—}3><token_{—}1> encrypted with second symmetric key (user ID)</token_{—}1>; <token_{—}2> encrypted with first symmetric key (symmetric_key_{—}3)</token_{—}2></token_{—}3>

It should be understood, that the third token can be generated in a number of ways. For example, the third token itself can be encrypted with the second symmetric key. This further step provides an additional layer of protection against traffic analysis attacks aimed at discovering the third symmetric key.

The first transmitter (320) sends (step 430) the third token to the client computer (105).

Typically a token is implemented as a cookie (i.e., a data block). When the cookie is sent to a client computer comprising a Web browser, the cookie is stored on the client computer in the Web browser's cache memory.

The user sends (step 435) a request for a resource, for example an HTTP request for a web page, to Server 2. The request comprises the third token. If the token is a cookie, the cookie is sent with an HTTP request. In another implementation, the token can be included as a parameter included in a header associated with the HTTP request. In another implementation, the token can be included as a parameter in all subsequent HTTP requests through the standard process of URL rewriting.

Because Server 1 and Server 2 already have the same symmetric key (i.e., the first and second symmetric keys), in response to receiving the third token, the decryptor (325) decrypts (step 440) the first token using the second symmetric key in order to obtain the user ID. The decryptor (325) also decrypts (step 445) the second token using the first symmetric key received from the administrator (115) in order to obtain the third symmetric key.

In response to an unsuccessful decryption the process ends. Alternatively, a notification can be sent to the administrator (115).

In response to a successful decryption at step 440, the authorizer (330) uses the client computer identity in the token in order to determine whether the user is authorized to access the resource. In response to a successful authorization, Server 2 sends a response (step 450) (e.g. a HTTP response) to the client computer (105). Content associated with the resource (e.g. a web page) can then be sent from Server 2 to the client computer (105).

In response to a successful decryption at step 445, Server 2 obtains the third symmetric key that is the updated symmetric key to the second symmetric key. It should be understood that the third symmetric key can now be used in subsequent communications.

It should be understood that the preferred embodiment can be implemented in a number of ways. For example, a client computer authenticates with Server 1. The client computer then receives an updated symmetric key in a token from Server 2. In a subsequent communication, the client computer transmits the token to Server 1.

It should be understood that a user can access multiple SSO environments. Thus, there is a need for an associated client computer to present a token to a server in the correct SSO environment.

In one example, an SSO environment can be defined by a DNS domain. Thus, a client computer determines a hostname associated with a server and presents a token to a server with a hostname within a given DNS domain. In another example, a client computer can maintain and/or access a list of servers within a given SSO environment. When a client computer accesses a server, the client computer presents a token comprising an identifier associated with the SSO environment for which a token is valid.

Advantageously, by one server adding an updated symmetric key to the token, the preferred embodiment allows for the updated symmetric key to be transmitted to other servers in the SSO environment.

The preferred embodiment advantageously utilizes existing communication flows between a user and servers in a SSO environment in order to transmit an updated symmetric key between the servers in the SSO environment. Advantageously, a method of transmitting an updated symmetric key, when a key change is required, is provided which overcomes problems associated with the prior art. That is, manual effort or complex scripts are not required in order to transmit the updated symmetric key. Furthermore, network connections between servers are not required in order to transmit the updated symmetric key.

Furthermore, when a user authenticates with one server, the user is used to securely transmit a token between servers, despite the user being un-trusted (i.e., because the user can present any data when presenting a token to other servers). That is, by using an initial symmetric key (i.e., the first symmetric key) to encrypt data in the second token, a secure method by which an updated symmetric key is transmitted and received is provided.

Because a user is used by a server to distribute an updated symmetric key, preferably, extra security features are provided.

In one such security feature, a pre-selected user or set of users is nominated to transmit an updated symmetric key via a token. The user can be pre-selected based on an authentication threshold, for example wherein it is determined whether the user is authenticated at a particular access level threshold.

Furthermore, preferably, a user does not receive a symmetric key in clear text form.

Furthermore, since the second symmetric key can be changed to a third, fourth and later symmetric key, this key is less prone to attack, for example from traffic analysis.

Furthermore, since typically, the first symmetric key is less regularly used to encrypt data, the first symmetric key is less prone to attacks (e.g. from traffic analysis).

Because a user is used by a server to distribute an updated symmetric key, preferable extra reliability and assurance of distribution features are provided.

For example, multiple users can be used to distribute a given symmetric key from Server 1 to Server 2, so that there is redundancy in key distribution.

For example, a portion of an updated symmetric key is added by a first server to a token that is sent to a first user. The remaining portion of the updated symmetric key is added by the first server to a token that is sent to a second user. Thus, when the first user and the second user transmit the portions to a second server, the second server generates the updated symmetric key by utilizing the portions. Thus, increased security is provided by splitting the updated symmetric key, because the first user would need to know about (i.e., in order to collaborate with) the second user in order to obtain the remaining portion of the updated symmetric key, or vice versa. Furthermore, a third party would need to know about both users in order to obtain the portions of the updated symmetric key.

When different subsets of a symmetric key are distributed via different users, it is possible that all of the users may not connect to a second server after first connecting to a first server. Thus, preferably, an error correction code is used, which facilitates the entire symmetric key being reconstructed by a second server even if a configurable percentage of users do not later connect to the second server after first receiving their subset of a symmetric key from the first server.

Preferably, if an updated symmetric key is transmitted to a second server, the second server sends an acknowledgement that it has received the updated symmetric key to a first server. Preferably, the first server begins to use the updated symmetric key in subsequent communications only after receiving an acknowledgement of the receipt of the updated symmetric key from a second server in the SSO environment.

Because a user is used by a server to distribute an updated symmetric key, preferably extra coordination features are provided to allow servers to coordinate a time period during which a given symmetric key is valid for use.

In one example, a time period is pre-configurable, during which a given symmetric key is valid. Thus, the given symmetric key is valid for encrypting a token only within the configured time period. Preferably, a token that is presented to a server that has been encrypted by a symmetric key that was valid in a previous time period is rejected and/or an administrator is notified.

In one embodiment, the time period is configured by an administrator. In another embodiment, the time period is configured by a server. Preferably, data associated with the time period is included in a token (e.g. a token comprising an updated symmetric key).

In another example, a rolling subset of symmetric keys is valid. For example, until a first server receives an acknowledgement that an updated symmetric key has been received by a second server or if a client computer presents a token to the first server, wherein the token has been generated by the second server and encrypted with the updated symmetric key, a token generated by the second server using a previous symmetric key can be permitted for a grace period.

In response to determining that the grace period is nearing expiry, for example by comparison against a time threshold, a notification is sent to the administrator, so that the administrator can perform analysis such as, for example a determination of a cause of the updated symmetric key failing to reach the second server.

At the expiration of the grace period, preferably a token encrypted using the previous symmetric key is rejected and/or an administrator is notified.

It should be understood, that although the preferred embodiment has been described in relation to symmetric keys, the preferred embodiment can be used with other data such as a shared secret, public/private keys pairs, and the like.

What is claimed is:

1. A system for updating first security data, for use with a first server and a second server, wherein the first server and the second server have access to the first security data; and wherein a user is enabled to communicate with the first server and the second server; the system comprising:
a generator for generating a first token comprising second security data, wherein the first token is secured by applying the first security data; and
a communication component for transmitting, via the first server, the first token to the user and operable to permit the user to communicate the first token to the second server;
and wherein the second server is operable to obtain the second security data by applying the first security data to the first token.

2. A system as claimed in claim 1, further comprising an authenticator for authenticating the user.

3. A system as claimed in claim 2, further comprising a first selection component for selecting a server to generate the second security data.

4. A system as claimed in claim 3, wherein the first selection component selects a server in accordance with data associated with the user's communication with the selected server.

5. A system as claimed in claim 4, wherein data associated with the selected server is added to the first token.

6. A system as claimed in claim 1, wherein the generator generates a second token comprising a third token associated with credentials of the user and the first token.

7. A system as claimed in claim 6, wherein at least one of the first token and second token comprises an identifier associated with an environment having the first server and the second server.

8. A system as claimed in claim 2, further comprising a second selection component for selecting the user to communicate the first token to the second server.

9. A system as claimed in claim 2, further comprising a third selection component for selecting a plurality of users to communicate a plurality of tokens to the second server.

10. A system as claimed in claim 9, wherein the generator adds a plurality of portions of the second security data to the plurality of tokens.

11. A system as claimed in claim 10, wherein in response to receiving the plurality of tokens, the second server aggregates the plurality of portions of the second security data to generate the second security data.

12. A system as claimed claim 9, wherein the second server uses an error correction code.

13. A system as claimed in claim 9, wherein in response to receiving the second security data, the second server sends an acknowledgment to the first server.

14. A system as claimed in claim 13, wherein in response to receiving the acknowledgment, the first server utilizes the second security data.

15. A system as claimed claim 1, wherein the second security data is used for a pre-configurable time period.

16. A system as claimed in claim 15, wherein the generator generates a second token comprising a third token associated with credentials of the user and the first token and data associated with the time period is added to at least one of: the first token and the second token.

17. A system as claimed in claim 1, wherein the first security data is used for a pre-configurable time period.

18. A computer program product for updating first security data, for use with a first server and a second server, wherein the first server and the second server have access to the first security data; and wherein a user is enabled to communicate with the first server and the second server, the computer program product comprising a computer usable medium having computer usable program code tangibly embedded therein, the computer usable medium comprising:
computer usable program code configured to generate a first token comprising second security data, wherein the first token is secured by applying the first security data; and
computer usable program code configured to transmit, via the first server, the first token to the user and operable to permit the user to communicate the first token to the second server; and
computer usable program code configured to enable the second server to obtain the second security data by applying the first security data to the first token.

19. A computer program product as claimed in claim 18, further comprising computer usable program code configured to enable the generator to generate a second token comprising a third token associated with credentials of the user and the first token.
